(19) United States
(12) Patent Application Publication
(10) Pub. No.: US 2006/0044186 A1
(43) Pub. Date: Mar. 2, 2006

(54) Dual band antenna system

(76) Inventors: Francesco Coppi, Torino (IT); Mauro Francavilla, Torini (IT); Andrea Schiavoni, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/523,735

(22) PCT Filed: Aug. 4, 2003
(86) PCT No.: PCT/EP03/08603

§ 371 Date: Jan. 26, 2005

(30) Foreign Application Priority Data
Aug. 7, 2002 (IT) T02002A000704

(51) Int. Cl. H01Q 1/38

(52) U.S. Cl. 343/700 MS

(57) ABSTRACT

The antenna system for transceiving signals on two frequency bands is small, very efficient and capable of simultaneously transmitting and receiving signals on two frequency bands, while ensuring high decoupling between the two. Two or more microstrip antennas (1A, 1B, 1C, 1D) are arranged on a single dielectric substrate (2), provided with a ground plane (3), equipped with their own feed connection (6) and arranged so as to minimise reciprocal coupling.

### TECHNICAL FIELD

The invention refers to telecommunication apparatuses for wireless connections, specifically a system of antennas for transceiving signals on two frequency bands.

### BACKGROUND ART

Terminals whose internal circuits and antennas are capable of operating in several bands, e.g. terminals capable of supporting the two GSM standards—GSM900 and GSM1800—by using the 900 MHz and the 1800 MHz band respectively, have been developed over the past years, in the wake of the mass diffusion of mobile telephone systems.

These terminals—which include laptop computers, car fitted transceivers, etc., in addition to telephones—require antennas that are both very efficient, to provide connections even when the electromagnetic field is low, and which are not cumbersome, so as not to jeopardise portability.

Additionally, the need to transmit and/or receive large amounts of data, greater than that which currently supported by normal GSM systems, is increasingly more felt. This need can be satisfied by designing a terminal that can simultaneously receive and transmit on two frequency bands, e.g. two GSM bands, or on different channels in the same frequency band.

An antenna system characterised by minimum size, maximum efficiency and the possibility of operating in the same band or on different bands, while ensuring maximum band decoupling for transmitting and receiving at the same time, must be used to reach this objective.

The various antenna types known today include microstrip antennas, which are very thin and operate on two frequency bands. An example of dual band antenna is illustrated in the IEEE Trans. “On Antenna Propagation”, May 1998, Vol. 46, No. 4, pp. 596-598, “A Compact PIFA Suitable for Dual Frequency 900/1800-MHz Operation”. The article describes a PIFA (Planar Inverted F Antenna) in which a capacitative load is arranged In correspondence with the open end of the antenna and which consists of a metallic plane parallel to the ground plane. In this way, the resonant length is reduced by λ/4 to λ/8. Moreover, feed is capacitive; this is because the antenna is fed via an auxiliary reed arranged between the ground plane and the antenna itself. The capacitative load reduces the size of the antenna but also reduces the amplitude of the band, whereby complicating dual channel transmission in both of the two bands.

Another type of dual band antenna is described in IEE Electronics Letters, March. 1996, Vol. 32, No. 7, “Dual-band antenna for hand-held portable telephones”. The antenna described in this article consists of two separate radiating elements, namely a rectangular element for the 1800 MHz band and an L-shaped element for the 900 MHz band. Two separate coaxial feeds are provided for the two elements; this arrangement increases independence of the two resonating frequencies of the structures but at the same time makes the antenna feed layout more complicated. The two elements are connected to ground via metallic pins located near the coaxial feeds. This configuration presents poor decoupling between the two feeds.

Wireless telecommunication devices employing several antennas include the device described in international patent application WO 0104994. This employs an antenna system, in which one antenna is used to receive GPS (Global Positioning System) signals, another is used for transceiving radiotelephone signals and a possible third antenna, operating on lower frequencies, is arranged between the other two, which also performs shielding functions. In this case, since all antennas are reciprocally different, they can operate simultaneously only on different bands where services of a different nature are provided.

### BRIEF DESCRIPTION OF THE INVENTION

The antenna system for transceiving signals on two frequency bands according to the invention overcomes the aforesaid shortcomings and solves the technical problems described; the antenna system can simultaneously transmit and receive a variety of signals on one or two frequency bands of the same service, ensuring a high degree of decoupling between the two, being characterised by its small size and high efficiency.

Specifically, the invention refers to an antenna system for transceiving signals on two frequency bands as described in the preamble to claim 1.

An additional object of the invention is a multichannel mobile transceiving apparatus as described in the preamble to claim 11.

### BRIEF DESCRIPTION OF THE FIGURES

Additional characteristics of the invention will now be described, by way of example only, with reference to the following description of a preferred form of embodiment and the accompanying drawings in which:

FIG. 1 is a perspective view of an antenna;

FIG. 2 is a cross-sectional view of an antenna;

FIG. 3 is a perspective view of an antenna system;

FIG. 4 is a Cartesian chart illustrating the reflection coefficient pattern on the single antenna input port, according to frequency;

FIG. 5 is a Cartesian chart illustrating the decoupling pattern between the various antennas, according to frequency;

FIG. 6 is a radiation chart of an antenna at a frequency of 0.92 GHz;

FIG. 7 is a radiation chart of an antenna at a frequency of 1.80 GHz.

### DESCRIPTION OF A PREFERRED EMBODIMENT

The antenna system according to the invention is a device consisting of microstrip antennas arranged on a single dielectric substrate, which is compact, and suitable for inserting in small containers. There are four antennas in the example below, but the system may comprise any number of antennas, both odd and even, from a minimum of two, thanks to good reciprocal decoupling that ensures that the reciprocal influence is very low.

Each antenna has a coaxial feed, which can be connected to a different transceiver or combiner of two or more antennas and is positioned to minimise coupling with other antennas in the system.

To ensure minimum thickness, each antenna is made of a microstrip. This is a planar technique, which is used to produce transmission lines or antennas employing strips or reeds of conductive metal deposited on one side of a dielectric substrate; a layer of metallic material is arranged on the other side to connect the line or antenna to ground. The shape and dimensions of the strip characterises the behaviour and performance of the microstrip antenna.

The substrate typically consists of a dielectric material strip the thickness of which is constant. In particular, the characteristics of the antenna—radiation chart, band, reflection coefficient, etc.—vary with the geometric or electrical characteristics of the substrate.

As known, microstrip antennas are typically resonant. A distinction can be made between various types of resonant structures according to the employed resonance mode.

The most common type is called λ/2 (where λ is the wavelength), because the antenna has a length equal to λ/2, where λ is related to the resonant frequency at which radiation occurs.

A second type of resonating structures are called quarter-waves because the length of one of the antennas is equal to λ/4, where λ is related to the resonant frequency. This resonating mode is established in the presence of a λ/4 short-circuit to ground. There may be various resonating modes in an antenna, so that it can be used at several frequencies corresponding to these modes.

The four antennas used in this system are of the PIFA type, operating according to the described method. They represent a valid solution in terms of compactness and are capable of operating on two frequency bands, for example two GSM bands.

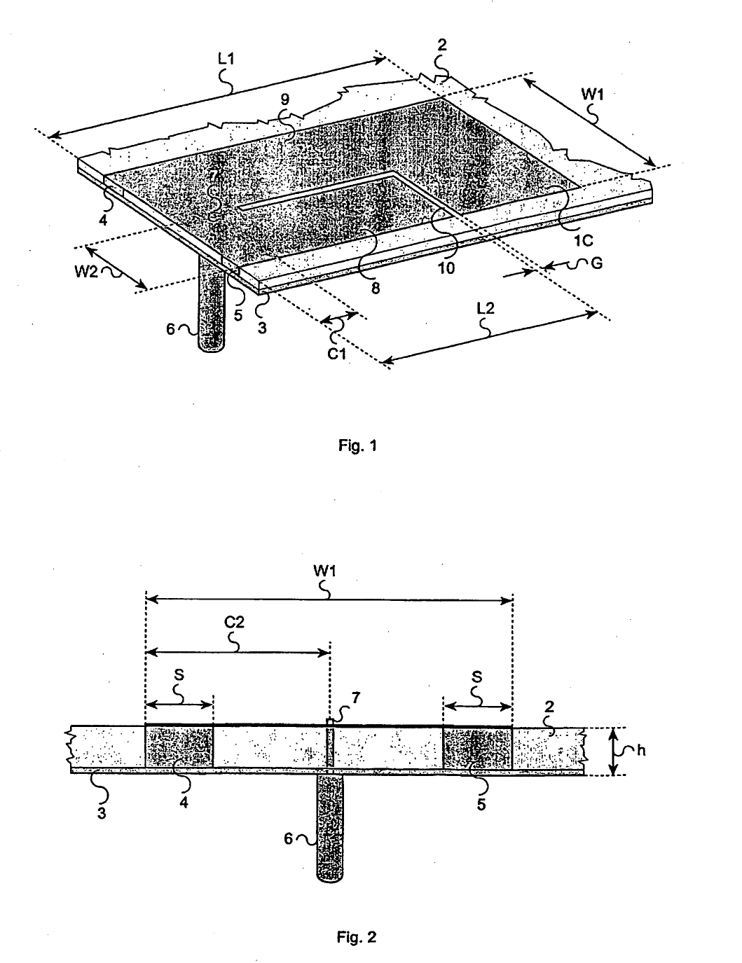

The single PIFA antenna, as shown in FIG. 1, consists of two radiating elements formed of metallic strips, one of which is rectangular and indicated by reference number 8, and the other is L-shaped and indicated by reference number 9. The two strips are arranged on a dielectric substrate 2, separated by a gap 10 and joined in the feed area 7.

A continuous strip 3 is arranged on the opposite side of the dielectric substrate with ground plane functions. Two short-circuits 4 and 5, arranged at the short end of the antenna on the edges of the substrate, connect the radiating elements to the ground plane. They make it possible to operate on two bands by establishing two 24 resonant modes. The first resonant mode is generated by strip 9, and the second is generated by the smaller strip 8.

As illustrated more clearly in FIG. 2, a coaxial wire 6 feed is used for each of the four antennas with equal characteristic impedance, for example 50 Ω. The external shielding of the coaxial wire is connected to the ground plane 3 and the inner core is connected to the antennas in point 7.

As mentioned, the system must present suitable radiation characteristics, specifically:
reflection coefficient frequency behaviour at the feed port S₁₁ capable of obtaining the best possible radiation efficiency in the required bands (i.e. in the 890-960 and 1710-1880 MHz ranges, in the case of the GSM 900 and 1800 bands);
sufficient decoupling between the four PIFA antennas forming the system.

These characteristics can be obtained by optimising the physical dimensions of each antenna, the thickness of the dielectric layer, the ground plane dimensions and the arrangement of the antennas.

The dimensions given below are expressed in terms of wavelength λ₀ at a frequency of 900 MHz (the midband frequency of the GSM 900 band). The antenna operating bands vary by varying λ₀; consequently system dimensions will be λ₀/λ₁≈2 where λ₁ is the wavelength at the upper resonating frequency. The system can be made with a tolerance of ±5% on the quantities shown below.

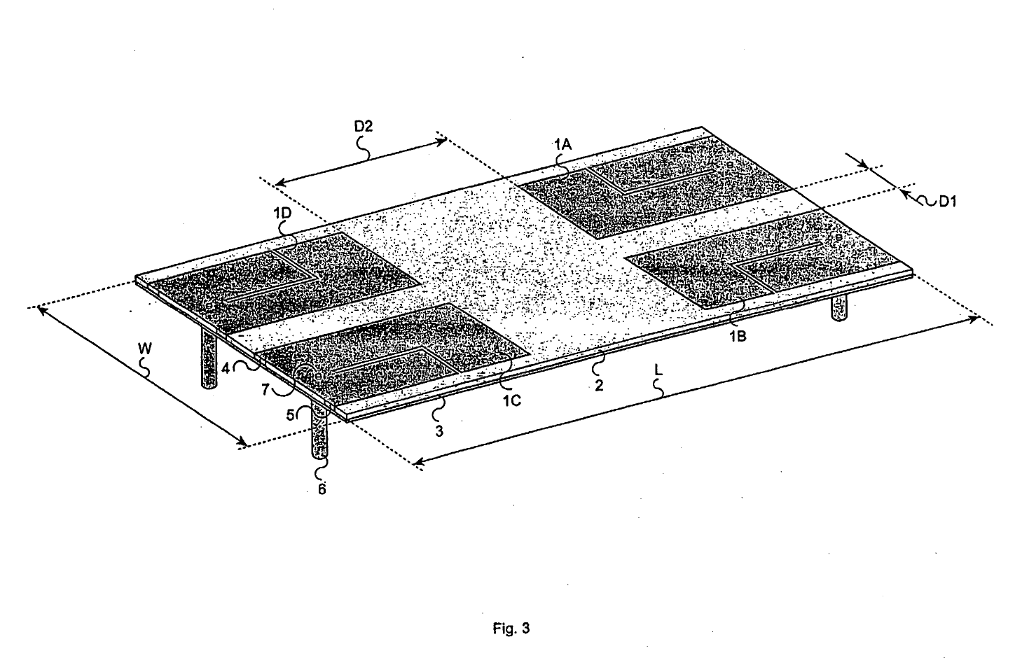

As shown in FIG. 3, a system of antennas in the GSM900 and 1800 bands require the presence of the following parts:
a electrical substrate 2, rectangular in shape, with relative dielectric constant 2.33 and thickness h=1.6 mm; the dimensions of the substrate are W=0.21λ₀ and L=0.42λ₀;
a conductive copper layer 3 on the lower side of the substrate, extended on the entire surface to form the ground of the antenna; any thickness in excess of 10 μm is possible, e.g. one of the normally marketed sizes, 17 μm or 35 μm;
the four antennas 1A, 1B, 1C and 1D, located at the vertex of the upper side of the substrate and arranged to mirror the symmetry axes of the substrate. With this arrangement, the radiating elements operating on the lower band have a shielding effect between the elements operating on the upper band, consequently improving decoupling. The symmetric condition, however, may be respected only for one of the axes, especially if there is a greater number of antennas, e.g. 6. With reference to FIG. 1, the dimensions of each antenna are L1=0.144λ₀, W1=0.0792λ₀, L2=0.0912λ₀, W2=0.0408λ₀ and G=0.0024λ₀. The distances between the antennas, shown in FIG. 3, are D1=0.0276λ₀ and D2=0.132λ₀, with a tolerance of up to ±10%;
two short-circuits 4, 5, thickness S=0.0096λ₀ (FIG. 2).

As mentioned, each antenna is fed by a coaxial wire 6 whose inner core is connected to the position defined by the dimensions C1=0.0144λ₀ (FIG. 1) and C2=0.0264λ₀ (FIG. 2).

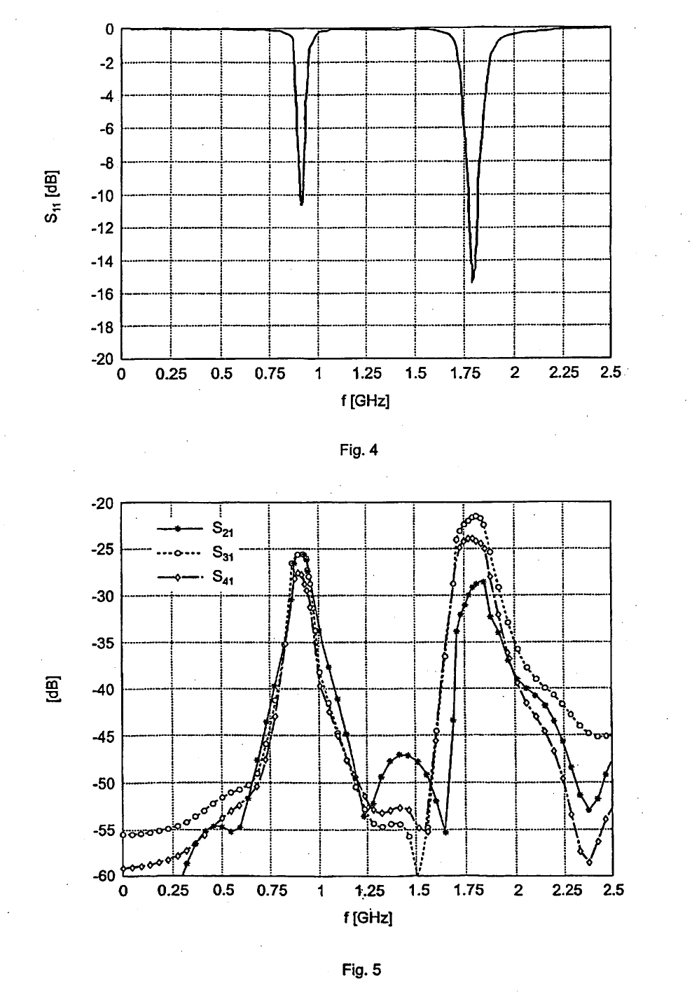

FIG. 4 shows the reflection coefficient pattern, i.e. the ratio S₁₁ expressed in dB between the amplitude of the reflected signal and the amplitude of the signal at the input port of one of the four antennas according to frequency. The minimum values corresponding to the two frequency bands are wide enough to permit simultaneous transmission and recepton.

FIG. 5 shows the decoupling pattern between the various radiating elements that form the device. Parameter S₂₁, expressed in dB, indicates the amplitude of the signal received by the antenna 1B and the amplitude of the signal sent to the antenna 1A, which is fed.

Similarly, the parameter S₃₁ relates to antenna 1C, and S₄₁ relates to antenna 1D, while antenna 1A is always fed.

The results show that the decoupling between the various antennas in the system better than −20 dB throughout the band.

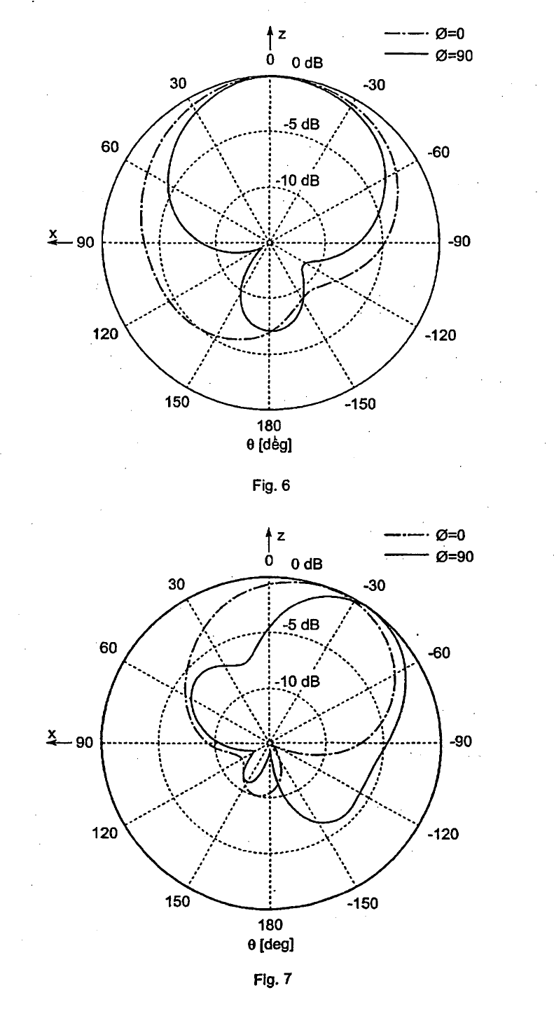

Finally, FIG. 6 shows the radiation chart of one of the antennas at a frequency of 920 MHz and FIG. 7 shows the radiation chart at a frequency of 1800 MHz. These frequencies correspond to the midband frequencies of the two GSM bands.

The previously illustrated antenna system can be used to advantage in a multichannel transceiving apparatus in which several transceivers operate on different frequency bands and/or on different channels in the same frequency band. The antenna system, being planar and globally very small in size, makes the mobile transceiving apparatus very compact and easily transportable by an operator.

An example of a multichannel mobile transceiving apparatus is a mobile television filming station intended to be carried and operated by a single operator, e.g. a reporter moving on the territory to document an event, such as a sports event, a crime, a natural event, etc.

A mobile television filming station made according to the invention may consist of the following elements:
a camera, e.g. a video camera of the currently manufactured type capable of generating an analogue video signal, e.g. in PAL format, or a signal already converted into digital form, e.g. DV or Webcam formats;
a processing unit for encoding and compressing the video signal from the video camera, e.g. using MPEG standard, capable of splitting the encoded video signal into several data flows;
several mobile telephone terminals, inserted, for example, in a public telephone network (e.g. GSM900/1800 network), for the remote transmission of data flows, each mobile terminal being provided with at least one transceiver;
a planar multiple antenna, comprising a system of antennas made according to the previously illustrated specifications, in which each antenna is connected to a corresponding transceiver.

Naturally, this description is an example only. Variants and changes may be implemented without departing from the scope of the present invention, as defined by the following claims.

1. Antenna system for transceiving signals on two frequency bands, in which two or more microstrip antennas (1A, 1B, 1C, 1D) are arranged on a single dielectric substrate (2), provided with a ground plane (3), characterised by the fact that each of said antennas is capable of operating simultaneously on a lower frequency band (λ₀) and on a higher frequency band (λ₁), is provided with a single feed connection (6) and is positioned to ensure decoupling with the other antennas better than −20 dB in the same frequency band.

2. Antenna system according to claim 1, characterised by the fact that the antennas (1A, 1B, 1C and 1D) are arranged on the upper side of the dielectric substrate (2) and are reciprocally distanced by 0.0276λ₀ (D1) and 0.132λ₀ (D2), with a tolerance of ±10% on the indicated quantifies.

3. Antenna system according to claim 1, characterised by the fact that the antennas (1A, 1B, 1C and 1D) are arranged to mirror either one or both of the symmetry axes of said rectangular substrate (2).

4. Antenna system according to claim 1, characterised by the fact that each antenna (1A, 1B, 1C and 1D) is of the PIFA type, equipped with a radiating element for each frequency band and two short-circuits (4, 5) which are arranged on the short side of the antenna on the edges of the dielectric substrate (2) and are connected to the radiating elements of the ground plane (3).

5. Antenna system according to claim 1, characterised by the fact that said dielectric substrate (2) has a dielectric constant equal to 2.33 and a thickness (H) equal to 1.6 mm, with dimensions equal to 0.21λ₀ (W) for 0.42λ₀ (L) and a tolerance of ±5% on the quantities shown.

6. Antenna system according to claim 1, characterised by the fact that said ground plane (3) is arranged on the lower side of the substrate (2), is extended on the entire surface and has a thickness of more than 10 μm.

7. Antenna system according to claim 1, characterised by the fact that each of said antennas (1A, 1B, 1C, 1D) has dimensions equal to 0.144λ₀ (L1), 0.0792λ₀ (W1), 0.0912λ₀ (L2), 0.0408λ₀ (W2) and 0.0024λ₀ (G), with a tolerance of ±5% on the quantities shown.

8. Antenna system according to claim 1, characterised by the fact that said short-circuits (4, 5) has a thickness equal to 0.0096λ₀ (S), with a tolerance of ±5%.

9. Antenna system according to claim 1, characterised by the fact that each antenna is fed in positon 0.0144λ₀ (C1) and 0.0264λ₀ (C2), with a tolerance of ±5% on the quantities shown.

10. Antenna system according to claim 1, characterised by the fact that said upper frequency band has a wavelength at the resonating frequency (λ₁), which is approximately half of that (λ₀) of said lower frequency.

11. Multichannel mobile transceiving apparatus characterised by the fact that it comprises:
Several transceivers capable of operating on different frequency bands and/or on different channels in the same frequency band;
a planar multiple antenna, comprising a system of antennas made according to any of the previous claims, in which each antenna is connected to a corresponding transceiver of said transceiving apparatus.

12. Apparatus according to claim 11, in which said transceivers operate in the GSM900 and GSM1800 bands.
